(19) United States
(12) Patent Application Publication
(10) Pub. No.: US 2017/0061406 A1
(43) Pub. Date: Mar. 2, 2017

(54) METHOD AND SYSTEM FOR PERIODIC SAVING USING ACCOUNT CONTROLS

(71) Applicant: MasterCard International Incorporated, Purchase, NY (US)

(72) Inventors: Beth C. ADAMS, Newtown, CT (US); Maria Carola CORTI, Toronto (CA); Louise Ann LORIGGIO, Tarrytown, NY (US); Suzanne E. WATTERS, Oakland, NJ (US); Gregory James BARRETT, Ridgefield, CT (US); Rohnny Jean Lucien SWENNEN, Waterloo (BE); Victoria G. COWLES, Ridgefield, CT (US); Silvana MILLER, White Plains, NY (US)

(73) Assignee: MasterCard International Incorporated, Purchase, NY (US)

(21) Appl. No.: 15/251,492

(22) Filed: Aug. 30, 2016

Related U.S. Application Data
(60) Provisional application No. 62/212,208, filed on Aug. 31, 2015.

(51) Int. Cl. G06Q 20/10; G06Q 20/34

(52) U.S. Cl. CPC G06Q 20/108; G06Q 20/35785

(57) ABSTRACT

A method for periodic savings and usage via transaction controls includes: storing an account profile, the profile including a primary account number and account balance; receiving a saving request, the request including a period of time, periodic amount, total amount, and transaction criteria; storing a transaction control in the account profile that prevents usage of a saved amount of the account balance where the saved amount corresponds to the periodic amount; increasing the saved amount by the periodic amount after the period of time; repeating the increasing step until the saved amount is equal to or greater than the total amount; and updating the transaction control to prevent usage of the saved amount outside of a payment transaction in compliance with the one or more transaction criteria.

### FIELD

The present disclosure relates to periodic saving using account controls, specifically the use of transaction controls in a transaction account to enable the periodic saving for a later purchase, particularly for transaction accounts funded via outside sources such that traditional saving methods are unfeasible.

### BACKGROUND

Parents, employers, and other similar entities often provide money to children, employees, and other subordinates to make purchases. A parent may give their child cash to buy lunch at school, an employer may give an employee a company payment card to use on a business trip, a homeowner may give a housekeeper a payment card to purchase products for the home, etc. In each of these instances, the entity providing the money or payment instrument to the other often loses control and oversight of how money is being spent. For instance, the child may spend the cash on toys instead of lunch, the employee may make personal purchases during the trip, and the housekeeper may treat themselves to a free lunch at the homeowner's expense. In order to help prevent such occurrences, some entities may use controlled payment numbers for control and oversight of subordinate spending.

For example, a parent may provide their child with access to their transaction account, but place transaction controls on the account such that the child is unable to conduct unauthorized payment transactions. In some methods, a separate controlled payment number may be given to the child, such that the parent's transactions are unaffected by the controls. In addition, some methods have been developed to enable the parent to receiving notifications of attempted transactions by the child, which must be explicitly authorized by the parent to be successfully processed. Such methods may provide greater control for parents, employers, and other entities over subordinate spending, while also providing oversight to not only prevent unauthorized usage but also to monitor usage for added assurance.

However, such methods often lack tools to provide benefits to the subordinates themselves. For instance, a child may wish to place limits on their own spending, such as to save up money for a larger purchase. For example, a child may want to save up money in order to buy an expensive electronic gadget, but not be restricted entirely in usage of their available funds. In many instances, the child may be unable to access transaction controls for their account entirely. In other instances, transaction controls may be available, but may be inefficient for saving over time as the child must manually add, modify, and update the transaction controls throughout time and at specific periods of time for periodic saving.

Thus, there is a need for a technical solution to enable periodic saving of funds in a single transaction account via the use of transaction controls that requires minimal effort on the part of the account user. By utilizing transaction controls, the savings may be established without the use of a secondary account or requiring fund transfers, which may be ideal for subordinate users of a transaction account that do not have access to secondary accounts or fund transfers, and may also be accomplished without continual adjustment and modification to controls by the account user.

### SUMMARY

The present disclosure provides a description of systems and methods for periodic savings and usage via transaction controls.

A method for periodic savings and usage via transaction controls includes: storing, in an account database of a processing server, an account profile, wherein the account profile includes a structured data set related to a transaction account including at least a primary account number and an account balance; receiving, by a receiving device of the processing server, a data signal from a computing device, the data signal being superimposed with a saving request, wherein the saving request includes at least a period of time, a periodic amount, a total amount, and one or more transaction criteria; storing, by a querying module of the processing server, a transaction control in the account profile in the account database, wherein the transaction control prevents usage of a saved amount of the account balance for the related transaction account and where the saved amount corresponds to the periodic amount; increasing, by a control processing module of the processing server, the saved amount associated with the transaction control stored in the account profile by the periodic amount after the period of time; repeating, by the control processing module of the processing server, the increasing step until the saved amount is equal to or greater than the total amount; and updating, by the querying module of the processing server, the transaction control to prevent usage of the saved amount outside of a payment transaction in compliance with the one or more transaction criteria.

A system for periodic savings and usage via transaction controls includes an account database, a receiving device, a querying module, a control processing module of a processing server. The account database of the processing server is configured to store an account profile, wherein the account profile includes a structured data set related to a transaction account including at least a primary account number and an account balance. The receiving device of the processing server is configured to receive a data signal from a computing device, the data signal being superimposed with a saving request, wherein the saving request includes at least a period of time, a periodic amount, a total amount, and one or more transaction criteria. The querying module of the processing server is configured to store a transaction control in the account profile in the account database, wherein the transaction control prevents usage of a saved amount of the account balance for the related transaction account and where the saved amount corresponds to the periodic amount. The control processing module of the processing server is configured to: increase the saved amount associated with the transaction control stored in the account profile by the periodic amount after the period of time; and repeat the increasing step until the saved amount is equal to or greater than the total amount. The querying module of the processing server is further configured to update the transaction control to prevent usage of the saved amount outside of a payment transaction in compliance with the one or more transaction criteria.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for periodic savings and usage via transaction controls via a subordinate user of a transaction account in accordance with exemplary embodiments.

FIG. 2 is a block diagram illustrating the processing server of FIG. 1 for periodic savings and usage in a controlled transaction account via transaction controls in accordance with exemplary embodiments.

FIG. 3 is a flow diagram illustrating a process for the periodic savings and usage in a transaction account using the processing server of FIG. 2 in accordance with exemplary embodiments.

FIG. 4 is a flow chart illustrating an exemplary method for periodic savings and usage via transaction controls in accordance with exemplary embodiments.

FIG. 5 is a flow diagram illustrating the processing of a payment transaction in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, prepaid account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit, or otherwise provides a consumer with a transaction account for use in funding payment transactions. In many instances, the issuer may be a bank or other financial institution authorized to open transaction accounts used to fund a payment transaction. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

Controlled Payment Number—Controlled payment numbers may be payment numbers associated with a payment account that are subject to one or more rules. In many cases, these rules may be set by a cardholder, such as spending limits, limits on days and/or times of a transaction, limits on merchants or industries, transaction spending or frequency limits, etc. Controlled payment numbers may offer an account holder an opportunity to give payment cards tied to the account to others for use, but subject to rules set by the cardholder, such as an employer distributing cards to employees, or a parent distributing cards to children. Additional detail regarding controlled payment numbers may be found in U.S. Pat. No. 6,636,833, issued Oct. 21, 2003; U.S. Pat. No. 7,136,835, issued Nov. 14, 2006; U.S. Pat. No. 7,571,142, issued Aug. 4, 2009; U.S. Pat. No. 7,567,934, issued Jul. 28, 2009; U.S. Pat. No. 7,593,896, issued Sep. 22, 2009; U.S. patent application Ser. No. 12/219,952, filed Jul. 30, 2008; U.S. patent application Ser. No. 12/268,063, filed Nov. 10, 2008; and U.S. patent application Ser. No. 12/359,971, filed Jan. 26, 2009; each of which are herein incorporated by reference in their entirety.

### System for Periodic Savings in a Controlled Transaction Account

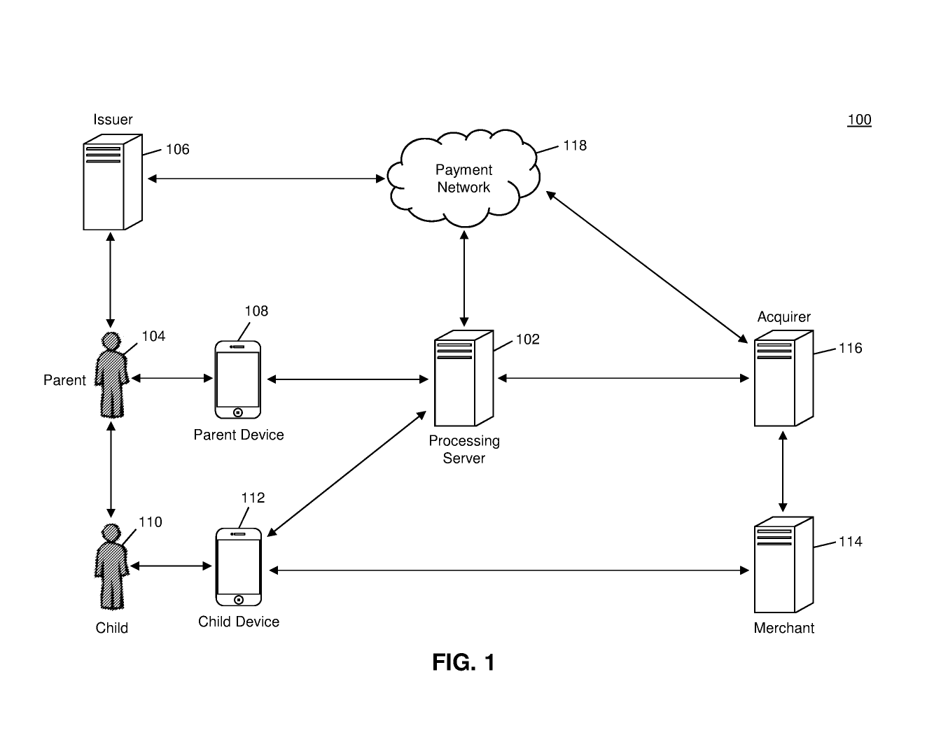

FIG. 1 illustrates a system 100 for periodic savings in a controlled transaction account via automatically modified transaction controls.

The system 100 may include a processing server 102. The processing server 102 may be configured to provide for periodic savings in a transaction account via the use of transaction controls. In the system 100, a parent 104 may have a transaction account established with an issuer 106, which may be a financial institution, such as an issuing bank, or other entity configured to maintain, manage, or otherwise be associated with transaction accounts for usage by the parent 104 in funding payment transactions. As discussed herein, the “parent” 104 may be any entity that is associated with a transaction account that has supervisory control thereof for establishing account controls and providing funding to a secondary transaction account or controlled payment number for usage associated therewith. For example, the parent 104 may be interchangeable with a supervisor, employer, etc.

The parent 104 may possess or otherwise be associated with a parent device 108. The parent device 108 may be a computing device suitable for use in managing and using account functions of their associated transaction account, such as a desktop computer, laptop computer, notebook computer, tablet computer, cellular phone, smart phone, smart watch, smart television, wearable computing device, implantable computing device, etc. The parent 104 may use the parent device 108 to establish a transaction account or access to their associated transaction account to a child 110. As discussed herein, the “child” 110 may be any entity that is associated with a transaction account for which another entity, e.g., the parent 104, may have supervisory control thereof. For example, the child 110 may be interchangeable with an employee, subordinate, etc.

The child 110 may be given access to the transaction account via an electronic wallet application program on a child device 112. The child device 112 may be a computing device suitable for use in managing and using account functions of their associated transaction account, such as a desktop computer, laptop computer, notebook computer, tablet computer, cellular phone, smart phone, smart watch, smart television, wearable computing device, implantable computing device, etc. The transaction account may be a separate transaction account established for the child 110 and funded by the parent's transaction account, or may be the parent's transaction account for which the child 110 is issued a controlled payment number. The transaction account may be a credit account, debit account, prepaid account, or any other suitable type of transaction account. The transaction account may be funded by the parent 104, and may also be funded by additional entities and associated transaction accounts, such as other relatives, friends, etc. In such instances, the transaction account may be funded via payments by the funding transaction accounts or may be funded as the child's transaction account is used, such as by rules established for determining funding rates by each funding transaction account. For example, the parent's transaction account may fund 80% of purchases by the child 110 while two grandparents' transaction accounts may each fund 10% of the purchases.

In some embodiments, the child's transaction account, which may herein be referred to as a “secondary transaction account,” may be associated with the same issuer 106 as the funding transaction account. In other embodiments, the child's transaction account may be associated with a different issuer 106. For example, the parent 104 may create the secondary transaction account for the child 110 with a different issuing financial institution, such as one that provides greater control to the parent 104 or other benefits for funding and managing the child's transaction account.

In instances where the child's transaction account is a debit or prepaid account, the transaction account may have a balance that is established based on funding paid for by the funding transaction accounts. In instances where the child's transaction account is a credit account, the credit limit may be based on an available credit limit of the funding transaction accounts or based on a funding amount provided from the associated funding transaction accounts. For example, the parent 104 may choose to fund the child's transaction account with $500, which may increase the available credit limit for use by the child 110 by $500.

When funding the transaction account, the parent 104 may also establish transaction controls for usage of the associated funds. The transaction controls may be controls placed on the transaction account such that transactions conducted by the child 110 must be in compliance with the controls for successful processing of the payment transaction. Transaction controls may include, for example, controls on transaction amount, aggregate transaction amount, transaction time and/or date, geographic location, merchant, merchant category, number of transactions, transaction frequency, product, product category, type of transaction, type of point of sale, etc. In instances where the child 110 has a controlled payment number to the parent's transaction account, the transaction controls may not be applicable to the parent's usage of the account. For example, the transaction controls may be applicable only to the controlled payment number and not to the real account number.

Payment credentials for the transaction account may be provisioned to the child device 112 using a suitable method that will be apparent to persons having skill in the relevant art. The child 110 may then use the transaction account to fund a payment transaction at a merchant 114 by presenting the child device 112 and conveying payment credentials therefrom to a point of sale system of the merchant 114. For instance, the child device 112 may electronically transmit the payment credentials in a data signal transmitted using near field communication, the child device 112 may display a machine-readable code encoded with the payment details that may be read by an optical reader of the merchant's point of sale system, etc. In some instances, the child device 112 may electronically transmit the payment credentials to the merchant 114 via the Internet, such as in an e-commerce transaction conducted via a merchant website or application program using the child device 112.

The merchant 114 may submit the payment credentials along with additional transaction data to an acquirer 116, which may be a financial institution, such as an acquiring bank, or other entity configured to maintain, manage, or otherwise be associated with transaction accounts for usage by the merchant 114 in conducting payment transactions and receiving funds. The acquirer 116 may receive the payment credentials and the additional transaction data and generate a transaction message for the payment transaction. The transaction message may be a specialized data message that is formatted pursuant to one or more standards governing the transmission and exchange of financial transaction messages, such as the International Organization for Standardization's ISO 8583 standard. The transaction message may include a plurality of data elements, each data element configured to store data as set forth in the associated standard(s). For instance, the transaction message may include a data element configured to store a primary account number associated with the transaction account used to fund the transaction (e.g., the controlled payment number associated with the child's transaction account) and additional data elements configured to store the additional transaction data. The additional transaction data may include, for example, a transaction amount, transaction time, transaction date, geographic location, merchant identifier, merchant name, merchant category code, product data, point of sale data, issuer data, acquirer data, reward data, loyalty data, offer data, etc. In some instances, the transaction message may also include a message type indicator, which may be indicative of a type of message for the transaction message, such as an authorization request, authorization response, etc.

The acquirer 116 may submit the generated transaction message to a payment network 118 for processing via the payment rails, which may be specialized network infrastructure associated with the payment network 118 used for the transmission of transaction messages, as discussed in more detail below. The payment network 118 may identify that the primary account number stored in the associated data element is a controlled payment number and may route the transaction message to the processing server 102. In some embodiments, the processing server 102 may be a part of the payment network 118 and receive the transaction message directly from the acquirer 116 or as part of the internal processing of the payment network 118. In other embodiments, the acquirer 116 may submit the transaction message directly to the processing server 112, which may forward the transaction message on to the payment network 118 if the primary account number is not a controlled payment number.

The processing server 102 may identify the transaction account associated with the payment transaction based on the controlled payment number and may then validate compliance of the payment transaction with the account's transaction controls based on the transaction controls and the additional transaction data stored in the data elements of the transaction message. If the transaction is not in compliance with the transaction controls, then the processing server 102 may forward a transaction message (e.g., a copy of the received transaction message) to the acquirer 116 (e.g., via the payment network 118) that includes a message type indicator indicative of an authorization response and a data element configured to store a response code indicative of a denial. The acquirer 116 may receive the authorization response, which may be forward to the merchant 114 and the merchant 114 may inform the child 110 of the denial of the payment transaction. If the transaction is in compliance with the transaction controls, the transaction message may be forwarded on to the issuer 106 (e.g., via the payment network 118) for processing of the payment transaction using traditional methods and systems. In instances where the controlled payment number may be associated with the parent's transaction account, the processing server 102 may swap the controlled payment number for the real account number prior to the forwarding of the transaction message.

As part of the conducting of payment transactions using the controlled transaction account, the child 110 may desire to save money for a later transaction. For example, the child 110 may be receiving regular funding by the parent 104 of $30 a week, but may want to save up to purchase a $75 item. Rather than withholding from all spending for three weeks, the child 110 may want to establish a periodic savings of $10 a week for eight weeks, at which time they will be able to purchase the item using the saved amount.

In order to establish the periodic saving for the amount, the child 110 may electronically transmit a savings request to the processing server 102. The savings request may be superimposed on a data signal electronically transmitted to the processing server 102 by the child device 112 using a suitable communication network, such as a cellular communication network, the Internet, a local area network, etc. In some instances, communications between the child device 112 and processing server 102 may be routed through one or more computing systems, application programs, platforms, etc. The savings request may include information identifying the transaction account, such as an account identifier, information associated with the savings, and one or more transaction criteria associated with the eventual desired purchase.

The account identifier may be a unique value suitable for use in identification of the transaction account, such as the controlled payment number or primary account number, a username, an e-mail address, a phone number, a device identifier (e.g., associated with the child device 112), or other suitable value. The information associated with the savings may be, for example, a period of time, periodic saving amount, and total amount. In another example, the information associated with the savings may be the total amount and total period, where the processing server 102 may calculate the periodic saving amount and period of time based thereon. In some instances, the information associated with the savings may be a combination, such as a total amount and a period of time, with the periodic saving amount being determined by the processing server 102. The transaction criteria associated with the eventual purchase may be criteria suitable for use in establishing one or more transaction controls such that the total amount saved may be usable only for the desired purchase and not for other payment transactions.

The processing server 102 may receive the saving request, may identify the associated transaction account, and may establish a transaction control based thereon. The transaction control may be a control that prohibits the usage of the periodic saving amount in payment transactions. Such a control may be implemented in any suitable fashion, such as by preventing usage of that amount, by placing a control on an aggregate transaction amount equal to the account balance minus the periodic saving amount, etc. In the latter instance, the transaction control may be adjusted by the processing server 102 each time additional funding is provided to the transaction account, such as by increasing the aggregate transaction amount by the funding amount such that the same periodic saving amount remains prohibited from use.

After each period of time has elapsed, the processing server 102 may modify the transaction control such that the amount being saved increases by the periodic saving amount. For example, if the transaction control is configured to prevent usage, then the amount being prevented may be increased by the periodic saving amount. The processing server 102 may continue to repeat the process after the elapse of every period of time until the saved amount is equal to or greater than the total amount indicated in the saving request. The processing server 102 may then modify the transaction controls such that the total amount is usable in a payment transaction that is in compliance with the one or more transaction criteria included in the saving request. In some instances, modification may include removal of the transaction control preventing usage, and the addition of one or more transaction controls associated with the transaction criteria. In some cases, the one or more transaction controls may still prevent usage of the total amount in instances where payment transactions do not comply with the transaction criteria, such as to ensure that the total amount remains reserved for use in the desired transaction. When the processing server 102 receives a transaction message with transaction data that is in compliance with the transaction criteria, the transaction may be processed and the transaction controls subsequent removed if the transaction is approved.

The use of the transaction controls and modification thereof at periodic intervals to increase the saved amount may enable a child 110 to save up money in a controlled transaction account for a later purchase without the use of a secondary transaction account or requiring repeated modification to transaction controls by the child 110. In addition, the conversion of the transaction controls to account for the later purchase once the desired amount has been met may ensure that not only is the amount saved, but the amount is eligible only for use with the desired transaction, which may prevent impulsive usage of the saved amount for a different purchase. As such, the processing server 102 and methods and systems discussed herein provide for greater efficiency and ease of usage for the child 110 as well as providing support for impulse control in addition to the savings. Furthermore, the processing server 102 provides a technical improvement to transaction processing systems via the specialized configuration and programming to ensure that the desired amount can be saved via increases over time, without the interruption of normal transaction processing and in a manner that prevents usage of the amount being saved, which may be unavailable in traditional saving methods.

In some instances, the processing server 102 may enable the child 110 to make modifications to the periodic savings. For instance, the child 110 may request (e.g., via the child device 112) a modification to the periodic savings amount, the total amount, the period of time, or the one or more criteria, such as in instances where the child 110 may want to change their target purchase, save up money faster, or stretch out the savings period. In some cases, the processing server 102 may be configured to enable the child 110 to cancel a period saving. In such a case, the child 110 may submit a request (e.g., via the child device 112) to the processing server 102 requesting removal of the periodic savings. The processing server 102 may receive the request, identify the associated transaction controls, and remove the transaction controls such that the saved amount is no longer restricted from use. Such an action may be suitable, for example, in instances where the child 110 purchases the item using additional money available in their transaction account and no longer needs to save for the product. In some embodiments, the parent 104 may receive (e.g., via the parent device 108) a notification regarding the modification or removal of a periodic saving, or may be required to provide confirmation to a modification or removal of a periodic saving.

In some embodiments, the transaction account and usage thereof may also include additional features for use by the parent 104 and child 110 to provide additional benefits to each of the entities in addition to periodic savings. For example, the processing server 102 may be configured to electronically transmit notifications to the parent 104 or child 110 via the parent device 108 or child device 112, respectively, based on criteria established by the processing server 102 or set by the parent 104 or child 110. For instance, the processing server 102 may notify the parent 104 and/or child 110 any time the child 110 conducts a transaction, any time a transaction is approved, any time a transaction is denied, any time a transaction is denied due to an account control, when money is being saved, when a total amount for saving is met, etc. In another example, the parent 104 may set a transaction control such that the parent 104 must provide authorization for any transaction involving the child 110 using the transaction account, or may provide override authorization for any payment transaction denied due to account controls.

In yet another example, the parent 104 or other funding entity may set one or more goals to be met by the child 110, such that when the goal is met the account balance may be increased as a result of additional funding. For instance, the parent 104 may set a reward for the finishing of chores by the child 110 or the performance of a physical activity. In such instances, the goals may be met via self-reporting by the child 110, such as using an application program of the child device 112, or based on data gathered and/or analyzed using the child device 112, such as by the tracking of physical activity using one or more application programs associated therewith of the child device 112.

In another example, the transaction account may be configured to enable for split payment of payment transactions involving others. For example, the application program of the child device 112 used to manage the transaction account and/or usage of the payment credentials may be configured to partially fund a payment transaction that is partially funded by one or more other transaction accounts using methods and systems that will be apparent to persons having skill in the relevant art. In some instances, the child 110 may be configured to make payments to another controlled transaction account, such as one funded by the same funding transaction account(s) or a separate account. In some embodiments, the parent 104 may be able to place controls on the funding of the child's transaction account by other entities or transaction accounts, such as by limiting funding amounts, requiring approval of funding transactions or transaction accounts for funding by the parent 104, etc.

In some instances, the controlled transaction account may be configured to earn rewards for purchases made therewith. In some cases, a reward program may be established that includes the controlled transaction account as well as funding transaction accounts. For example, the parent 104 and child 110 may both participate in a reward program for purchases made using the funding transaction account and controlled transaction account. In such instances, reward points or other value may be pooled together among the transaction accounts. For instance, the parent's funding transaction account may have an associated reward program for which transactions funded therewith earn points. Purchases made by the child 110 using the secondary transaction account may accumulate the same points associated with the funding transaction account, which may be used by the parent 104 and/or child 110. In some cases, the earning and usage of reward points and other value may be based on the funding of the secondary transaction account. For example, if the secondary transaction account is funded by two or more accounts, points earned via purchases using the secondary transaction account may be split up among the two or more funding accounts based on the proportion of funding provided thereby. In another example, the funding transaction account may receive a portion of the points earned by transactions involving the secondary transaction account. In some instances, reward points or other value in a pool associated with the secondary transaction account and one or more funding accounts may be subject to one or more controls on usage, such as by requiring confirmation of multiple (e.g., more than one, a majority, etc.) users associated with the transaction accounts. For example, usage of the reward points by the child 110 may require consent of the parent 104.

In another embodiment, the child 110 may request funding, such as a general increase in funding or a request for funding for a particular purchase. In some instances, the child 110 may request reimbursement for a purchase, such as by making a purchase and selecting (e.g., via the child device 112) the purchase for reimbursement where the parent 104, on approval, may provide funding to the controlled transaction account equal to the purchase amount. In some cases, the child 110 may be able to request a loan from the parent 104, which may be paid back over time via automatic transactions. The child 110 may also be able to set up recurring transactions using the controlled transaction account. In some instances, transaction controls may be established to prevent usage of amounts associated with recurring payment transactions, such as using methods discussed above, to ensure later recurring payment transactions are successful.

In some embodiments, the parent 104 may be provided with additional controls regarding the child's transaction account in addition to transaction controls. For example, the parent 104 may cancel the child's transaction account or withdraw funding, may enable or disable the withdrawal of cash from the controlled transaction account funds, may request a new controlled payment number be generated and issued to the child 110, may set up recurring funding (e.g., for allowance or other periodic funding of the child's transaction account), etc. In some instances, the processing server 102 may be configured to provide funds to the controlled transaction account in real-time from funding transaction accounts or otherwise make the funding amount available to the child 110 in real time.

In such embodiments, the controlled transaction account may be part of an ecosystem that includes the parent's transaction account as well as any additional funding transaction accounts. For example, a family, a business, or other entity may have a set of transaction accounts that are grouped together that include one or more funding accounts and one or more controlled transaction accounts (e.g., for multiple children, employees, subordinates, etc.) such that funds may be easily transferred for controlled usage by subordinates, transactions may be monitored, and grouped rewards may be earned, in addition to the ability for the subordinate users to establish periodic savings for their available funds.

### Processing Server

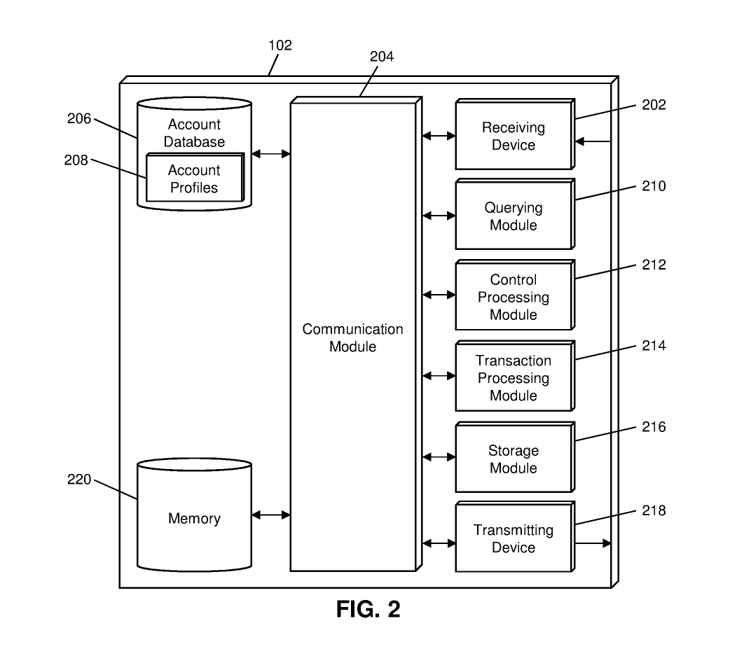

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 102.

The processing server 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 118 for the transmission of transaction messages that include sensitive financial data and information. In some instances, the receiving device 202 may also be configured to receive data from issuers 106, parent devices 108, child devices 112, merchants 114, acquirers 116, and payment networks 118, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically data signals that are transmitted, where data may be superimposed on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals from the child device 112 that are superimposed with savings requests. Savings requests may include account identifiers, periods of time, periodic amounts, total amounts, transaction criteria for associated transactions, and any other additional data suitable for use in establishing periodic savings via transaction controls as discussed herein. The receiving device 202 may also receive transaction messages from the payment network 118 and/or the acquirer 116 via the payment rails. In some embodiments, the receiving device 202 may also receive data signals from the parent device 108 and/or issuer 106 superimposed with data messages regarding additional controls and functionality of the controlled transaction account as discussed herein, such as data messages for funding requests, transaction control modification requests, goal establishing requests, etc.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 210, control processing module 212, transaction processing module 214, and storage module 216. As used herein, the term “module” may be software or hardware particularly programmed to receive an input, perform one or more processes using the input, and provide an output. The input, output, and processes performed by various modules will be apparent to one skilled in the art based upon the present disclosure.

The processing server 102 may include an account database 206. The account database 206 may be configured to store a plurality of account profiles 208 using a suitable data storage format and schema. In some instances, the account database 206 may be a relational database and may be configured for use of structured query language for the identification, access, modification, etc. of data stored therein. Each account profile 208 may be a structured data set configured to store a structured data set related to a controlled transaction account. The account profile 208 may include at least a primary account number associated with the related transaction account and an account balance, which may represent the amount of funding available for use by the child 110 associated with the related transaction account. In some instances, the account profile 208 may also include an account identifier and additional data suitable for use in performing the functions discussed herein.

For example, the account profile 208 may include account numbers and/or identifiers for one or more funding transaction accounts associated with the related transaction account. In some instances, a primary funding transaction account (e.g., associated with the parent 104) may be identified, with other funding transaction accounts being authorized thereby. In such instances, the account profile 208 may include one or more limits or controls on funding by the other transaction accounts. The account profile 208 may also include transaction controls set on usage of the transaction account in payment transactions, such as may be established by users associated with the funding accounts. In another example, the account profile 208 may include goals for earning additional funding, data regarding recurring payment transactions or loans, etc.

The querying module 210 of the processing server 102 may be configured to execute queries on databases to identify information. The querying module 210 may receive one or more data values or query strings, and may execute a query string based thereon on an indicated database, such as the account database 206, to identify information stored therein. The querying module 210 may then output the identified information to an appropriate engine or module of the processing server 102 as necessary. The querying module 210 may, for example, execute a query on the account database 206 to identify an account profile 208 and/or data stored therein, such as to identify an account profile 208 associated with a saving request received by the receiving device that includes the account identifier parsed therefrom.

The control processing module 212 may be configured to create, modify, update, remove, and otherwise manage transaction controls for controlled transaction accounts. The control processing module 212 may perform modifications and other management of transaction controls based on instructions received from the receiving device 202 (e.g., from the parent device 108, child device 112, etc.) as well as instructions based on internal processing of the processing server 102, such as following the expiration of periods of time with regard to periodic savings. For example, the control processing module 212 may create a transaction control based on a savings request submitted by a child 110 via the child device 112, where the transaction control prevents usage of a specific amount from the account balance for an account profile 208. The control processing module 212 may update the transaction control after the associated period of time by increasing the associated amount by the periodic amount. Once the amount reaches the total amount as indicated in the savings request, the control processing module 212 may be configured to update the transaction control to enable a transaction for the amount provided it is in compliant with transaction criteria included in the saving request. Once a transaction control is created, modified, removed, or otherwise managed by the control processing module 212, a query may be executed by the querying module 210 on the account database 206 to store or modify the transaction control accordingly in the account profile 208.

The transaction processing module 214 may be configured to perform processing of payment transactions. The processing may include the validation of transaction controls as applied to a payment transaction. When a transaction message is received, the querying module 210 may identify the account profile 208 related to the transaction account involved in the payment transaction (e.g., via the primary account number) and then the transaction processing module 214 may validate compliance or non-compliance with the transaction controls based on the transaction data stored in the additional data elements of the transaction message and the transaction controls. If the transaction is compliant with transaction controls, the transaction processing module 214 may produce an instruction to forward the transaction message to the associated issuer 106. If the transaction is non-compliant, the transaction processing module 214 may include a response code in a corresponding data element that indicates denial of the payment transaction and include a message type indicator in the transaction message indicative of an authorization response, and produce an instruction to forward the modified transaction message to the acquirer 116.

The storage module 216 may be configured to generate and store data in the account database 206 and other storage internal or external to the processing server 102. The storage module 216 may be included as part of the querying module 210 or may provide queries, instructions, or data values to the querying module 210 for use in the execution of queries on databases. For example, the storage module 216 may receive a modified transaction control from the control processing module 212, for which a query string may be generated by the storage module 216, which may be provided to the querying module 210 for execution for storage of the corresponding transaction control in the associated account profile 208.

In some embodiments, the processing server 102 may include additional modules configured to perform the functions discussed herein, such as the additional functions of the processing server 102 discussed above. For example, the processing server 102 may include a notification unit configured to generate notifications based on performed actions, such as when a transaction is denied due to transaction controls or when a target amount for periodic savings is met. In another example, the processing server 102 may include a recurring payment module configured to initiate payment transactions for recurring payments or loans. In yet another example, the processing server 102 may include an account processing module configured to process changes to controlled transaction accounts, such as conversion of a debit account to a credit account upon receipt of an instruction, such as by the request of the parent 104, if the child 110 reaches a specific age, if the account meets specific criteria, etc.

The processing server 102 may further include a transmitting device 218. The transmitting device 218 may be configured to transmit data over one or more networks via one or more network protocols. In some embodiments, the transmitting device 218 may be configured to transmit data over the payment rails, such as using specially configured infrastructure associated with payment networks 118 for the transmission of transaction messages that include sensitive financial data and information, such as identified payment credentials. In some instances, the transmitting device 218 may be configured to transmit data to issuers 106, parent devices 108, child devices 112, merchants 114, acquirers 116, payment networks 118, and other entities via alternative networks, such as the Internet. In some embodiments, the transmitting device 218 may be comprised of multiple devices, such as different transmitting devices for transmitting data over different networks, such as a first transmitting device for transmitting data over the payment rails and a second transmitting device for transmitting data over the Internet. The transmitting device 218 may electronically transmit data signals that have data superimposed that may be parsed by a receiving computing device. In some instances, the transmitting device 218 may include one or more modules for superimposing, encoding, or otherwise formatting data into data signals suitable for transmission.

The transmitting device 218 may be configured to electronically transmit a data signal to the child device 112 that is superimposed with data messages associated with management and use regarding periodic savings and other management of the controlled transaction account. Data messages may include, for example, notifications regarding savings requests, notifications regarding updates to associated transaction controls, notifications regarding the increase of a saved amount to a desired amount, account management notifications and messages, etc. The transmitting device 218 may also be configured to transmit transaction messages via the payment rails or an alternative suitable communication network, such as for transmitting transaction messages to the payment network 108, the acquirer 116, and/or the issuer 106. The transmitting device 218 may also be configured to transmit data associated with additional functions of the processing server 102, such as data messages to the parent device 108 for management and modification of the controlled transaction account and funding thereto.

The processing server 102 may also include a memory 220. The memory 220 may be configured to store data for use by the processing server 102 in performing the functions discussed herein. The memory 220 may be configured to store data using suitable data formatting methods and schema and may be any suitable type of memory, such as read-only memory, random access memory, etc. The memory 220 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art.

### Process for Managing and Usage Periodic Savings Via Transaction Controls

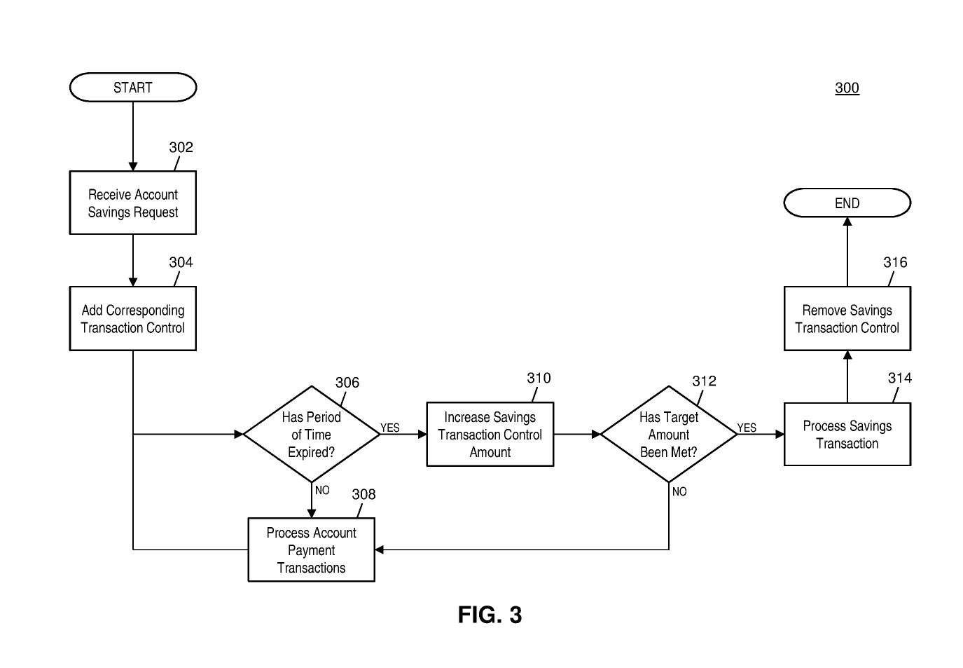

FIG. 3 illustrates a process 300 for the management and use of periodic savings in a controlled transaction account using transaction controls as implemented by the processing server 102 of the system 100.

In step 302, the receiving device 202 of the processing server 102 may receive a data signal from the child device 112 superimposed with an account saving request. The account saving request may include at least an account identifier, a period of time, a periodic amount, and one or more transaction criteria. In step 304, a transaction control associated with the account saving request may be stored in the associated account profile 208. The control processing module 212 of the processing server 102 may generate a transaction control based on the received saving request, which may be added to the account profile 208 associated therewith via a query executed by the querying module 210 to add the transaction control to the account profile 208 that includes the account identifier included in the account savings request.

In step 306, the control processing module 212 or other module or engine of the processing server 102 may determine if the period of time associated with the account savings request has expired. If the period of time has not yet expired, then, in step 308, payment transactions involving the related transaction account may be processed over the period of time. The processing of payment transactions may include the application of transaction controls for the transaction account to transaction data for each transaction to determine compliance thereto, where compliant payment transactions may have processing continued (e.g., sent to the payment network 118 and/or issuer 106 for additional processing) and where non-compliant payment transactions may be denied (e.g., a denial authorization response sent to the acquirer 116). Processing may also include prohibiting of usage of the amount being saved as set forth in the transaction control as related to the account savings request. The process may then continue to return to step 306 where expiration of the period is waited for with payment transactions being processed in the meantime.

When a period of time has expired, then, in step 310, the control processing module 212 of the processing server 102 may increase the savings amount for the transaction control by the periodic amount as indicated in the received account savings request. The increase may include the execution of a query by the querying module 210 to modify the data included in the account profile 208 to store the modified transaction control. In step 312, the control processing module 212 may determine if the target amount for the periodic savings has been met, as based on the increased saved amount and the total amount included in the account savings request. If the target amount has not been met, the process 300 may proceed to step 308 where payment transactions are identified and processed and the saved amount continues to increase as additional periods expire.

If the target amount is met, then, in step 314, a payment transaction corresponding to the periodic savings may be processed. The processing of the payment transaction may include the receipt of a transaction message by the receiving device 202 via the payment network 118 that includes transaction data stored in the additional data elements included therein that is compliant with the one or more transaction criteria associated with the periodic savings transaction control. If compliant, the transaction may be processed using traditional methods and systems, where the child 110 may make the purchase that they had saved up for via the periodic savings. In step 316, the transaction control associated with the savings request may be removed from the account profile 208 via the execution of a query on the account database 206 by the querying module 210 configured thereto.

### Exemplary Method for Periodic Savings and Usage Via Transaction Controls

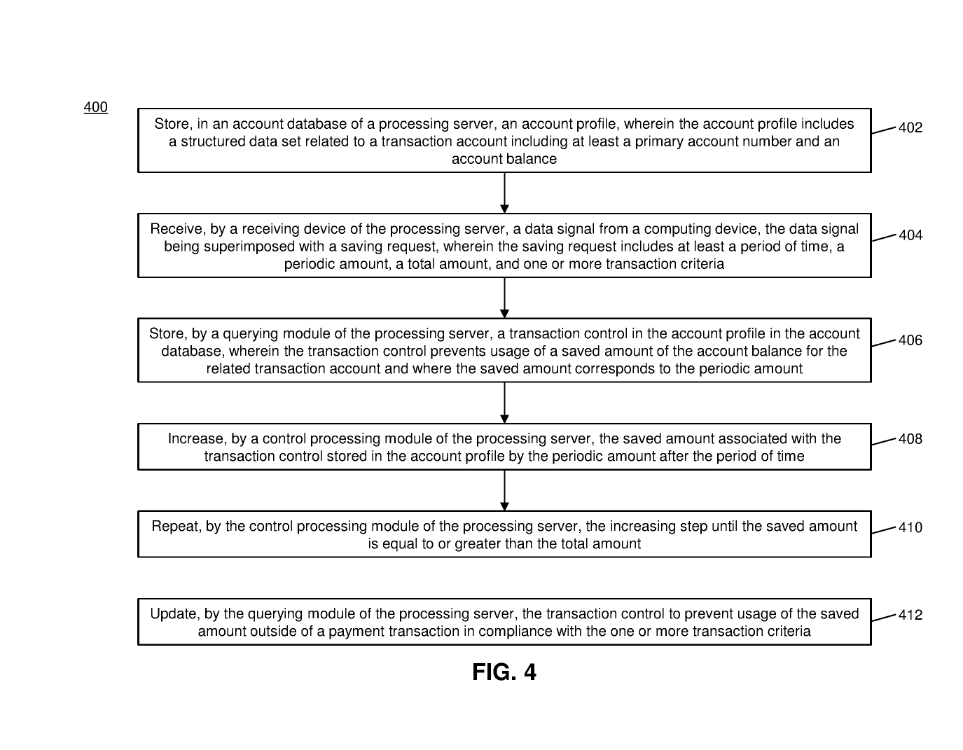

FIG. 4 illustrates a method 400 for periodic savings and usage thereof in a controlled transaction account via transaction controls and without the usage of a secondary transaction account.

In step 402, an account profile (e.g., account profile 208) may be stored in an account database (e.g., account database 206) of a processing server (e.g., the processing server 102), wherein the account profile includes a structured data set related to a transaction account including at least a primary account number and an account balance. In step 404, a data signal may be received by a receiving device (e.g., the receiving device 202) of the processing server from a computing device (e.g., the child device 112), wherein the data signal is superimposed with a saving request, the saving request including at least a period of time, a periodic amount, a total amount, and one or more transaction criteria

In step 406, a querying module (e.g., the querying module 210) of the processing server may execute a query on the account database to store a transaction control, wherein the transaction control prevents usage of a saved amount of the account balance for the related transaction account and where the saved amount corresponds to the periodic amount. In step 408, the saved amount associated with the transaction control stored in the account profile may be increased by a control processing module (e.g., the control processing module 212) of the processing server by the periodic amount after the period of time.

In step 410, the increasing step may be repeated by the control processing module of the processing server until the saved amount is equal to or greater than the total amount. In step 412, the transaction control may be updated by the querying module of the processing server to prevent usage of the saved amount outside of a payment transaction in compliance with the one or more transaction criteria.

In one embodiment, the method 400 may further include receiving, by the receiving device of the processing server, a transaction message related to a payment transaction via a payment network (e.g., the payment network 118), wherein the transaction message is formatted based on one or more standards and includes a plurality of data elements, including at least a first data element configured to store the primary account number and one or more additional data elements configured to store transaction data. In a further embodiment, the method 400 may even further include: validating, by a transaction processing module (e.g., the transaction processing module 214) of the processing server, compliance of the payment transaction with the one or more transaction criteria based on a comparison of the transaction data stored in the one or more additional data elements and the one or more transaction criteria; and electronically transmitting, by a transmitting device (e.g., the transmitting device 218) of the processing server, the transaction message to a financial institution (e.g., the issuer 106) associated with the related transaction account via the payment network.

In another further embodiment, the method 400 may even further include electronically transmitting, by the transmitting device of the processing server, a second transaction message to a financial institution via the payment network, wherein the transaction message further includes a second data element configured to store a transaction amount, the transaction data stored in the one or more additional data elements is not compliant with the one or more transaction criteria, and the financial institution is an acquiring financial institution (e.g., the acquirer 116) associated with a merchant involved in the payment transaction if the transaction amount stored in the second data element would cause usage of the saved amount based on the account balance stored in the account profile, and the financial institution is an issuing financial institution associated with the related transaction account if the transaction amount stored in the second data element would not cause usage of the saved amount based on the account balance stored in the account profile. In an even further embodiment, the second transaction message may be an authorization response including a response code indicative of denial of the payment transaction if the financial institution is an acquiring financial institution, and the second transaction message may be a copy of the received transaction message if the financial institution is an issuing financial institution.

In some embodiments, the method 400 may also include electronically transmitting, by the transmitting device of the processing server, a data signal to the computing device, the data signal being superimposed with a notification, wherein the notification includes an indication of availability of the saved amount for use in the payment transaction in compliance with the one or more transaction criteria. In one embodiment, the transaction account may be one of: a credit, debit, or prepaid account.

In some embodiments, wherein the one or more transaction criteria may include at least one of: a merchant name, a merchant identifier, a merchant category code, a product name, a product identifier, a product category, a transaction amount, a geographic location, and a time and/or date. In one embodiment, the transaction account may be funded by one or more associated transaction accounts. In some embodiments, the account profile may further include one or more additional transaction controls, and payment transactions involving the related transaction account may be subject to the one or more additional transaction controls.

### Payment Transaction Processing System and Process

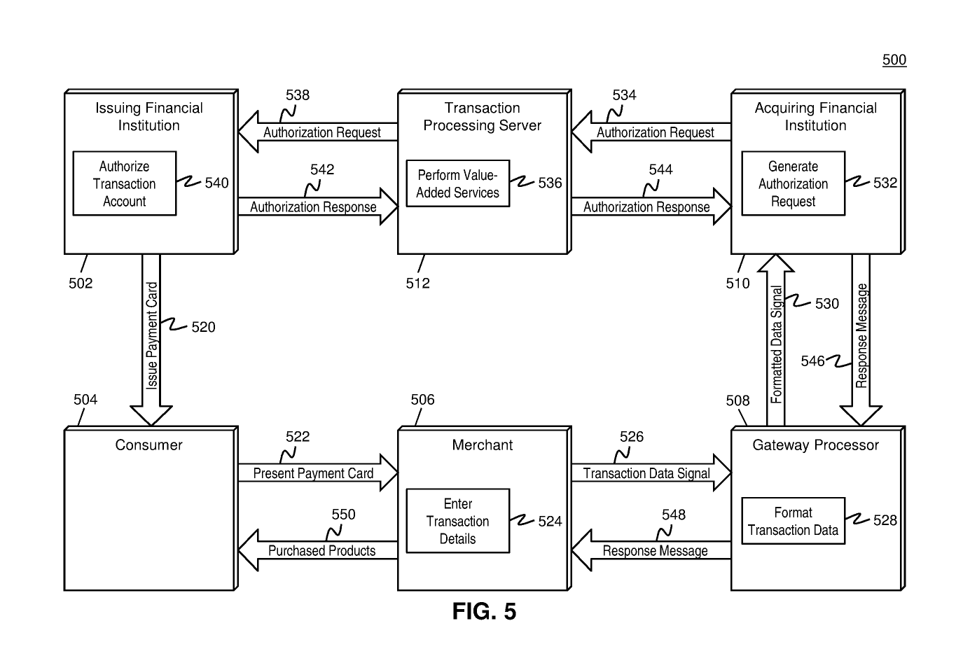

FIG. 5 illustrates a transaction processing system and a process 500 for the processing of payment transactions in the system. The process 500 and steps included therein may be performed by one or more components of the system 100 discussed above, such as the processing server 102, child 110, child device 112, merchant 114, acquirer 116, payment network 118, issuer 106, etc. The processing of payment transactions using the system and process 500 illustrated in FIG. 5 and discussed below may utilize the payment rails, which may be comprised of the computing devices and infrastructure utilized to perform the steps of the process 500 as specially configured and programmed by the entities discussed below, including the transaction processing server 512, which may be associated with one or more payment networks configured to processing payment transactions. It will be apparent to persons having skill in the relevant art that the process 500 may be incorporated into the processes illustrated in FIGS. 3 and 4, discussed above, with respect to the step or steps involved in the processing of a payment transaction. In addition, the entities discussed herein for performing the process 500 may include one or more computing devices or systems configured to perform the functions discussed below. For instance, the merchant 506 may be comprised of one or more point of sale devices, a local communication network, a computing server, and other devices configured to perform the functions discussed below.

In step 520, an issuing financial institution 502 may issue a payment card or other suitable payment instrument to a consumer 504. The issuing financial institution may be a financial institution, such as a bank, or other suitable type of entity that administers and manages payment accounts and/or payment instruments for use with payment accounts that can be used to fund payment transactions. The consumer 504 may have a transaction account with the issuing financial institution 502 for which the issued payment card is associated, such that, when used in a payment transaction, the payment transaction is funded by the associated transaction account. In some embodiments, the payment card may be issued to the consumer 504 physically. In other embodiments, the payment card may be a virtual payment card or otherwise provisioned to the consumer 504 in an electronic format.

In step 522, the consumer 504 may present the issued payment card to a merchant 506 for use in funding a payment transaction. The merchant 506 may be a business, another consumer, or any entity that may engage in a payment transaction with the consumer 504. The payment card may be presented by the consumer 504 via providing the physical card to the merchant 506, electronically transmitting (e.g., via near field communication, wireless transmission, or other suitable electronic transmission type and protocol) payment details for the payment card, or initiating transmission of payment details to the merchant 506 via a third party. The merchant 506 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 524, the merchant 506 may enter transaction details into a point of sale computing system. The transaction details may include the payment details provided by the consumer 504 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 506 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 506 may be an online retailer in an e-commerce transaction. In such embodiments, the transaction details may be entered in a shopping cart or other repository for storing transaction data in an electronic transaction as will be apparent to persons having skill in the relevant art.

In step 526, the merchant 506 may electronically transmit a data signal superimposed with transaction data to a gateway processor 508. The gateway processor 508 may be an entity configured to receive transaction details from a merchant 506 for formatting and transmission to an acquiring financial institution 510. In some instances, a gateway processor 508 may be associated with a plurality of merchants 506 and a plurality of acquiring financial institutions 510. In such instances, the gateway processor 508 may receive transaction details for a plurality of different transactions involving various merchants, which may be forwarded on to appropriate acquiring financial institutions 510. By having relationships with multiple acquiring financial institutions 510 and having the requisite infrastructure to communicate with financial institutions using the payment rails, such as using application programming interfaces associated with the gateway processor 508 or financial institutions used for the submission, receipt, and retrieval of data, a gateway processor 508 may act as an intermediary for a merchant 506 to be able to conduct payment transactions via a single communication channel and format with the gateway processor 508, without having to maintain relationships with multiple acquiring financial institutions 510 and payment processors and the hardware associated thereto. Acquiring financial institutions 510 may be financial institutions, such as banks, or other entities that administers and manages payment accounts and/or payment instruments for use with payment accounts. In some instances, acquiring financial institutions 510 may manage transaction accounts for merchants 506. In some cases, a single financial institution may operate as both an issuing financial institution 502 and an acquiring financial institution 510.

The data signal transmitted from the merchant 506 to the gateway processor 508 may be superimposed with the transaction details for the payment transaction, which may be formatted based on one or more standards. In some embodiments, the standards may be set forth by the gateway processor 508, which may use a unique, proprietary format for the transmission of transaction data to/from the gateway processor 508. In other embodiments, a public standard may be used, such as the International Organization for Standardization's ISO 8583 standard. The standard may indicate the types of data that may be included, the formatting of the data, how the data is to be stored and transmitted, and other criteria for the transmission of the transaction data to the gateway processor 508.

In step 528, the gateway processor 508 may parse the transaction data signal to obtain the transaction data superimposed thereon and may format the transaction data as necessary. The formatting of the transaction data may be performed by the gateway processor 508 based on the proprietary standards of the gateway processor 508 or an acquiring financial institution 510 associated with the payment transaction. The proprietary standards may specify the type of data included in the transaction data and the format for storage and transmission of the data. The acquiring financial institution 510 may be identified by the gateway processor 508 using the transaction data, such as by parsing the transaction data (e.g., deconstructing into data elements) to obtain an account identifier included therein associated with the acquiring financial institution 510. In some instances, the gateway processor 508 may then format the transaction data based on the identified acquiring financial institution 510, such as to comply with standards of formatting specified by the acquiring financial institution 510. In some embodiments, the identified acquiring financial institution 510 may be associated with the merchant 506 involved in the payment transaction, and, in some cases, may manage a transaction account associated with the merchant 506.

In step 530, the gateway processor 508 may electronically transmit a data signal superimposed with the formatted transaction data to the identified acquiring financial institution 510. The acquiring financial institution 510 may receive the data signal and parse the signal to obtain the formatted transaction data superimposed thereon. In step 532, the acquiring financial institution may generate an authorization request for the payment transaction based on the formatted transaction data. The authorization request may be a specially formatted transaction message that is formatted pursuant to one or more standards, such as the ISO 8583 standard and standards set forth by a payment processor used to process the payment transaction, such as a payment network. The authorization request may be a transaction message that includes a message type indicator indicative of an authorization request, which may indicate that the merchant 506 involved in the payment transaction is requesting payment or a promise of payment from the issuing financial institution 502 for the transaction. The authorization request may include a plurality of data elements, each data element being configured to store data as set forth in the associated standards, such as for storing an account number, application cryptogram, transaction amount, issuing financial institution 502 information, etc.

In step 534, the acquiring financial institution 510 may electronically transmit the authorization request to a transaction processing server 512 for processing. The transaction processing server 512 may be comprised of one or more computing devices as part of a payment network configured to process payment transactions. In some embodiments, the authorization request may be transmitted by a transaction processor at the acquiring financial institution 510 or other entity associated with the acquiring financial institution. The transaction processor may be one or more computing devices that include a plurality of communication channels for communication with the transaction processing server 512 for the transmission of transaction messages and other data to and from the transaction processing server 512. In some embodiments, the payment network associated with the transaction processing server 512 may own or operate each transaction processor such that the payment network may maintain control over the communication of transaction messages to and from the transaction processing server 512 for network and informational security.

In step 536, the transaction processing server 512 may perform value-added services for the payment transaction. Value-added services may be services specified by the issuing financial institution 502 that may provide additional value to the issuing financial institution 502 or the consumer 504 in the processing of payment transactions. Value-added services may include, for example, fraud scoring, transaction or account controls, account number mapping, offer redemption, loyalty processing, etc. For instance, when the transaction processing server 512 receives the transaction, a fraud score for the transaction may be calculated based on the data included therein and one or more fraud scoring algorithms and/or engines. In some instances, the transaction processing server 512 may first identify the issuing financial institution 502 associated with the transaction, and then identify any services indicated by the issuing financial institution 502 to be performed. The issuing financial institution 502 may be identified, for example, by data included in a specific data element included in the authorization request, such as an issuer identification number. In another example, the issuing financial institution 502 may be identified by the primary account number stored in the authorization request, such as by using a portion of the primary account number (e.g., a bank identification number) for identification.

In step 538, the transaction processing server 512 may electronically transmit the authorization request to the issuing financial institution 502. In some instances, the authorization request may be modified, or additional data included in or transmitted accompanying the authorization request as a result of the performance of value-added services by the transaction processing server 512. In some embodiments, the authorization request may be transmitted to a transaction processor (e.g., owned or operated by the transaction processing server 512) situated at the issuing financial institution 502 or an entity associated thereof, which may forward the authorization request to the issuing financial institution 502.

In step 540, the issuing financial institution 502 may authorize the transaction account for payment of the payment transaction. The authorization may be based on an available credit amount for the transaction account and the transaction amount for the payment transaction, fraud scores provided by the transaction processing server 512, and other considerations that will be apparent to persons having skill in the relevant art. The issuing financial institution 502 may modify the authorization request to include a response code indicating approval (e.g., or denial if the transaction is to be denied) of the payment transaction. The issuing financial institution 502 may also modify a message type indicator for the transaction message to indicate that the transaction message is changed to be an authorization response. In step 542, the issuing financial institution 502 may transmit (e.g., via a transaction processor) the authorization response to the transaction processing server 512.

In step 544, the transaction processing server 512 may forward the authorization response to the acquiring financial institution 510 (e.g., via a transaction processor). In step 546, the acquiring financial institution may generate a response message indicating approval or denial of the payment transaction as indicated in the response code of the authorization response, and may transmit the response message to the gateway processor 508 using the standards and protocols set forth by the gateway processor 508. In step 548, the gateway processor 508 may forward the response message to the merchant 506 using the appropriate standards and protocols. In step 550, the merchant 506 may then provide the products purchased by the consumer 504 as part of the payment transaction to the consumer 504.

In some embodiments, once the process 500 has completed, payment from the issuing financial institution 502 to the acquiring financial institution 510 may be performed. In some instances, the payment may be made immediately or within one business day. In other instances, the payment may be made after a period of time, and in response to the submission of a clearing request from the acquiring financial institution 510 to the issuing financial institution 502 via the transaction processing server 502. In such instances, clearing requests for multiple payment transactions may be aggregated into a single clearing request, which may be used by the transaction processing server 512 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 540), the transaction processing server 512 may be configured to perform authorization of transactions on behalf of the issuing financial institution 502. Such actions may be referred to as “stand-in processing,” where the transaction processing server “stands in” as the issuing financial institution 502. In such instances, the transaction processing server 512 may utilize rules set forth by the issuing financial institution 502 to determine approval or denial of the payment transaction, and may modify the transaction message accordingly prior to forwarding to the acquiring financial institution 510 in step 544. The transaction processing server 512 may retain data associated with transactions for which the transaction processing server 512 stands in, and may transmit the retained data to the issuing financial institution 502 once communication is reestablished. The issuing financial institution 502 may then process transaction accounts accordingly to accommodate for the time of lost communication.

In another example, if the transaction processing server 512 is unavailable for submission of the authorization request by the acquiring financial institution 510, then the transaction processor at the acquiring financial institution 510 may be configured to perform the processing of the transaction processing server 512 and the issuing financial institution 502. The transaction processor may include rules and data suitable for use in making a determination of approval or denial of the payment transaction based on the data included therein. For instance, the issuing financial institution 502 and/or transaction processing server 512 may set limits on transaction type, transaction amount, etc. that may be stored in the transaction processor and used to determine approval or denial of a payment transaction based thereon. In such instances, the acquiring financial institution 510 may receive an authorization response for the payment transaction even if the transaction processing server 512 is unavailable, ensuring that transactions are processed and no downtime is experienced even in instances where communication is unavailable. In such cases, the transaction processor may store transaction details for the payment transactions, which may be transmitted to the transaction processing server 512 (e.g., and from there to the associated issuing financial institutions 502) once communication is reestablished.

In some embodiments, transaction processors may be configured to include a plurality of different communication channels, which may utilize multiple communication cards and/or devices, to communicate with the transaction processing server 512 for the sending and receiving of transaction messages. For example, a transaction processor may be comprised of multiple computing devices, each having multiple communication ports that are connected to the transaction processing server 512. In such embodiments, the transaction processor may cycle through the communication channels when transmitting transaction messages to the transaction processing server 512, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 510 may identify that an authorization request involves an issuing financial institution 502 (e.g., via the bank identification number included in the transaction message) for which no value-added services are required. The transaction processor at the acquiring financial institution 510 may then transmit the authorization request directly to the transaction processor at the issuing financial institution 502 (e.g., without the authorization request passing through the transaction processing server 512), where the issuing financial institution 502 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 512 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 508, acquiring financial institution 510, etc.) for processing using this advanced network, and to quickly and efficiently receive a response regarding the ability for a consumer 504 to fund the payment transaction.

### Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for periodic savings and usage via transaction controls. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for periodic savings and usage via transaction controls, comprising:
storing, in an account database of a processing server, an account profile, wherein the account profile includes a structured data set related to a transaction account including at least a primary account number and an account balance;
receiving, by a receiving device of the processing server, a data signal from a computing device, the data signal being superimposed with a saving request, wherein the saving request includes at least a period of time, a periodic amount, a total amount, and one or more transaction criteria;
storing, by a querying module of the processing server, a transaction control in the account profile in the account database, wherein the transaction control prevents usage of a saved amount of the account balance for the related transaction account and where the saved amount corresponds to the periodic amount;
increasing, by a control processing module of the processing server, the saved amount associated with the transaction control stored in the account profile by the periodic amount after the period of time;
repeating, by the control processing module of the processing server, the increasing step until the saved amount is equal to or greater than the total amount; and
updating, by the querying module of the processing server, the transaction control to prevent usage of the saved amount outside of a payment transaction in compliance with the one or more transaction criteria.

2. The method of claim 1, further comprising:
receiving, by the receiving device of the processing server, a transaction message related to a payment transaction via a payment network, wherein the transaction message is formatted based on one or more standards and includes a plurality of data elements, including at least a first data element configured to store the primary account number and one or more additional data elements configured to store transaction data;

3. The method of claim 2, further comprising:
validating, by a transaction processing module of the processing server, compliance of the payment transaction with the one or more transaction criteria based on a comparison of the transaction data stored in the one or more additional data elements and the one or more transaction criteria; and
electronically transmitting, by a transmitting device of the processing server, the transaction message to a financial institution associated with the related transaction account via the payment network.

4. The method of claim 2, further comprising:
electronically transmitting, by a transmitting device of the processing server, a second transaction message to a financial institution via the payment network, wherein
the transaction message further includes a second data element configured to store a transaction amount,
the transaction data stored in the one or more additional data elements is not compliant with the one or more transaction criteria, and
the financial institution is an acquiring financial institution associated with a merchant involved in the payment transaction if the transaction amount stored in the second data element would cause usage of the saved amount based on the account balance stored in the account profile, and
the financial institution is an issuing financial institution associated with the related transaction account if the transaction amount stored in the second data element would not cause usage of the saved amount based on the account balance stored in the account profile.

5. The method of claim 4, wherein
the second transaction message is an authorization response including a response code indicative of denial of the payment transaction if the financial institution is an acquiring financial institution, and
the second transaction message is a copy of the received transaction message if the financial institution is an issuing financial institution.

6. The method of claim 1, further comprising:
electronically transmitting, by a transmitting device of the processing server, a data signal to the computing device, the data signal being superimposed with a notification, wherein the notification includes an indication of availability of the saved amount for use in the payment transaction in compliance with the one or more transaction criteria.

7. The method of claim 1, wherein the transaction account is one of: a credit, debit, or prepaid account.

8. The method of claim 1, wherein the one or more transaction criteria include at least one of: a merchant name, a merchant identifier, a merchant category code, a product name, a product identifier, a product category, a transaction amount, a geographic location, and a time and/or date.

9. The method of claim 1, wherein the transaction account is funded by one or more associated transaction accounts.

10. The method of claim 1, wherein
the account profile further includes one or more additional transaction controls, and
payment transactions involving the related transaction account are subject to the one or more additional transaction controls.

11. A system for periodic savings and usage via transaction controls, comprising:
an account database of a processing server configured to store an account profile, wherein the account profile includes a structured data set related to a transaction account including at least a primary account number and an account balance;
a receiving device of the processing server configured to receive a data signal from a computing device, the data signal being superimposed with a saving request, wherein the saving request includes at least a period of time, a periodic amount, a total amount, and one or more transaction criteria;
a querying module of the processing server configured to store a transaction control in the account profile in the account database, wherein the transaction control prevents usage of a saved amount of the account balance for the related transaction account and where the saved amount corresponds to the periodic amount; and
a control processing module of the processing server configured to
increase the saved amount associated with the transaction control stored in the account profile by the periodic amount after the period of time, and
repeat the increasing step until the saved amount is equal to or greater than the total amount, wherein
the querying module of the processing server is further configured to update the transaction control to prevent usage of the saved amount outside of a payment transaction in compliance with the one or more transaction criteria.

12. The system of claim 11, wherein the receiving device of the processing server is further configured to receive a transaction message related to a payment transaction via a payment network, wherein the transaction message is formatted based on one or more standards and includes a plurality of data elements, including at least a first data element configured to store the primary account number and one or more additional data elements configured to store transaction data;

13. The system of claim 12, further comprising:
a transaction processing module of the processing server configured to validate compliance of the payment transaction with the one or more transaction criteria based on a comparison of the transaction data stored in the one or more additional data elements and the one or more transaction criteria; and
a transmitting device of the processing server configured to electronically transmit the transaction message to a financial institution associated with the related transaction account via the payment network.

14. The system of claim 12, further comprising:
a transmitting device of the processing server configured to electronically transmit a second transaction message to a financial institution via the payment network, wherein
the transaction message further includes a second data element configured to store a transaction amount,
the transaction data stored in the one or more additional data elements is not compliant with the one or more transaction criteria, and
the financial institution is an acquiring financial institution associated with a merchant involved in the payment transaction if the transaction amount stored in the second data element would cause usage of the saved amount based on the account balance stored in the account profile, and
the financial institution is an issuing financial institution associated with the related transaction account if the transaction amount stored in the second data element would not cause usage of the saved amount based on the account balance stored in the account profile.

15. The system of claim 14, wherein
the second transaction message is an authorization response including a response code indicative of denial of the payment transaction if the financial institution is an acquiring financial institution, and
the second transaction message is a copy of the received transaction message if the financial institution is an issuing financial institution.

16. The system of claim 11, further comprising:
a transmitting device of the processing server configured to electronically transmit a data signal to the computing device, the data signal being superimposed with a notification, wherein the notification includes an indication of availability of the saved amount for use in the payment transaction in compliance with the one or more transaction criteria.

17. The system of claim 11, wherein the transaction account is one of: a credit, debit, or prepaid account.

18. The system of claim 11, wherein the one or more transaction criteria include at least one of: a merchant name, a merchant identifier, a merchant category code, a product name, a product identifier, a product category, a transaction amount, a geographic location, and a time and/or date.

19. The system of claim 11, wherein the transaction account is funded by one or more associated transaction accounts.

20. The system of claim 11, wherein
the account profile further includes one or more additional transaction controls, and
payment transactions involving the related transaction account are subject to the one or more additional transaction controls.

21. A method for sharing digital currency, comprising:
funding a transaction account using one or more additional transaction accounts, wherein
the transaction account is configured for one or more of: transaction controls set by account holder, transaction controls set by an account holder of the one or more additional transaction accounts, establishing of periodic savings, modification of periodic savings, transfer of funds to or from a similar funded transaction account, conversion into a different type of transaction account, partial payment for a payment transaction, recurring payments, loan repayment, increased funding upon goal completion, reward point earning, aggregation of reward points with the one or more additional transaction accounts, reward purchases, funding increase requesting, and reimbursement requesting.
